(19) United States
(12) Patent Application Publication
(10) Pub. No.: US 2005/0125907 A1
(43) Pub. Date: Jun. 16, 2005

(54) Substrate for artificial leathers, artificial leathers and production method of substrate for artificial leathers

(75) Inventors: Tsuyoshi Yamasaki, Okayama (JP); Norio Makiyama, Okayama (JP); Yoshihiro Tamba, Okayama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Kurashiki-shi (JP)

(21) Appl. No.: 11/001,008

(22) Filed: Dec. 2, 2004

(30) Foreign Application Priority Data
Dec. 12, 2003 (JP) 414241/2003

(51) Int. Cl. C14C 3/00; D06P 3/24

(52) U.S. Cl. 8/94.19 R

(57) ABSTRACT

The substrate for artificial leathers of the invention comprises an entangled nonwoven fabric which is mainly made of bundles of polyamide microfine fibers and an elastic polymer which is impregnated into intervening spaces in the entangled nonwoven fabric. The single fiber fineness of polyamide microfine fibers is 0.2 dtex or less. The bundles of polyamide microfine fibers have an average tenacity of 3.5 cN/dtex or more and an average elongation of 60% or less. Despite its extremely low apparent specific gravity of 0.30 or less, the substrate for artificial leathers exhibits high mechanical properties as evidenced by a tear strength of 50 N/mm or more. Thus, the substrate for artificial leathers is well balanced between the mechanical properties, feel and light weight which are required particularly in sport shoes applications to an extent not conventionally attained.

### BACKGROUND OF THE INVENTION

1. Field of the Invention

The present invention relates to artificial leathers and substrates for use as base fabrics of the artificial leathers, which have excellent mechanical properties, flexibility and dense feel, and are lighter in weight as compared with known like materials. The artificial leathers of the invention are suitable for use in general applications of artificial leathers, for example, materials for shoes such as men's shoes, women's shoes, children's shoes, sport shoes, outdoor shoes and working shoes; materials for bags such as brief bags, handbags and school children's bags; materials for clothing such as belts and garments; exterior finishing materials for furniture such as chairs, desks and closets; interior finishing materials for buildings such as wall papers and showcases; and interior finishing materials for vehicles such as cars, trains, air planes and ships. In addition, the artificial leathers are also applicable to industrial materials or sub-materials such as abrasives, water absorbents, oil absorbents and cushions. In particular, the artificial leathers of the invention are useful as upper materials for sports shoes for which the mechanical properties of base fabrics are important.

2. Description of the Prior Art

Various leather-like sheets have been suitably used in the above applications because of their capability of providing various high-grade appearances together with soft and dense feel. With respect to materials for the above applications, particularly, materials for sport shoes and outdoor shoes, the recent minimum requirement of consumers is directed to materials having more excellent, not minimum for practical use, mechanical properties while maintaining soft feel. Additionally, functional properties attracting consumer's willingness to buy, for example, light weight, are also required as current trend.

The leather-like sheets are roughly classified into grain-finished articles and napped articles, the base fabrics of any of which are made of fibrous sheet substrates having various fibrous structures. The fibrous sheet substrates are made into the substrates for artificial leathers having a natural leather-like feel by impregnating with a binder. Generally, the feel of the substrate for artificial leathers, and therefore, the feel of the leather-like sheet having the base fabric made thereof become softer as the single fiber fineness of fibers constituting the fibrous sheet substrate becomes finer. Since the appearance and elegance of touch in addition to the feel are significantly improved by raising the fibers constituting the substrate for artificial leathers to form a napped surface, fibers of a single fiber fineness more finer provides materials of higher grade.

Of the known leather-like sheets generally available, particularly, an artificial leather made of a fibrous sheet substrate having a nonwoven structure is characterized by its most distinctive feature of being excellent in mechanical properties and light in weight as compared with natural leathers. There have been made various proposals on the substrates for artificial leathers of lighter weight. However, it is quite difficult to reduce the weight while maintaining the soft and dense feel, let alone the mechanical properties. In case of the substrate for artificial leathers which is produced by converting sea-island fibers into microfine fibers by extractive removal of sea component before impregnating a binder resin into an entangled nonwoven fabric made of sea-island fibers or after making the impregnated binder resin into porous structure, the reduction of weight while maintaining the thickness means the reduction of the apparent specific gravity. One of easy methods for attaining this is to merely reduce the weights of fibers or resin per unit area of the substrate for artificial leathers. In this method, the apparent specific gravity is fairly easily reduced, for example, by reducing the weight of sea-island fibers or resin or by reducing the content of island component without changing the weight of sea-island fibers. However, the amount of structural component for forming the substrate for artificial leathers is also reduced correspondingly to the reduced amount of weight. Therefore, the substrate for artificial leathers which is to be produced through various treatments of continuous sheet will undergo a large change in its shape in proportion to the reduced degree of the structural component, in particular, will be significantly collapsed into the depth direction. Thus, the artificial leathers finally obtained are merely thinner, although having a similar apparent specific gravity as compared with those conventionally known.

To solve the above problems, hollow fibers have been dominantly used as the major fiber for constituting entangled nonwoven fabrics (for example, JP 11-081153 A, JP 2000-239972 A and WO 00/022,217). The hollow fibers have a single fiber fineness larger than that of microfine fibers produced from sea-island fibers, if the fiber weights are the same. Therefore, the substrates for artificial leathers can be made resistant to collapse into the depth direction by the use of hollow fibers. In addition, the hollow structure makes the apparent bulkiness of nonwoven fabric larger as compared with non-hollow fibers of the same fiber weight. Generally, the hollow fibers are divided based on the production method into those directly spun from spinneret of hollow structure- and those produced by extractive removal of the core component from sheath-core fibers; and divided based on the fiber cross section into single-hollow fibers and multi-hollow fibers. In addition, the fiber cross section and the hollow cross section are made into various forms and shapes. The hollow fibers are used in various manners, singly or in combination with non-hollow fibers.

In case of using any types of hollow fibers, the percentage of hollowness (ratio of the area of hollow portion to the area of overall cross section defined by fiber periphery) should be made as high as possible to ensure the reduction of weight of nonwoven fabric and resultant substrate for artificial leathers. Various proposals have been made on the method for attaining a high percentage of hollowness, and JP 11-100780 A proposes substrates for artificial leathers made of polyester hollow fibers having a high percentage of hollowness exceeding 40%. However, when the percentage of hollowness exceeds 40%, the hollow fibers are collapsed by various external forces not only in the fiber-forming process but also in the steps for producing the substrate for artificial leathers. Thus, a substantial portion of the hollow fibers in resultant nonwoven fabrics are collapsed into flat fibers or split, thereby failing to maintain the hollow state ideally. To maintain the hollow state, it can be proposed to make the hollow fibers hard enough to prevent the collapse under external forces or to make the hollow fibers resilient so as to elastically recover from collapse. Since the fibers for forming the nonwoven fabric are required to have a hardness for ensuring a sufficient bulkiness, a sufficient elastic recovery cannot be expected and the collapse at flex portions cannot be prevented. It will be impossible for hard hollow fibers to elastically recover if once collapsed. When the hollow fibers are collapsed, the nonwoven fabrics cannot maintain their high bulkiness to be collapsed particularly into the depth direction. Therefore, the apparent specific gravity of nonwoven fabrics becomes extremely larger than the designed apparent specific gravity to result in the production of artificial leathers having a similar weight or slightly reduced weight as compared with those conventionally known. To maintain a high percentage of hollowness, the nozzle structure should be made complicated, this increasing the apparent fineness of hollow fibers significantly. The substrates for artificial leathers made of such hollow fibers have an extremely hard feel and a poor dense feel, which are incomparably inferior to the feel of the substrates for artificial leathers made of microfine fibers.

As described above, in the conventional technique for producing substrates for artificial leathers from microfine fibers, it is quite difficult to reduce the weight although sufficient mechanical properties and soft feel can be provided. The use of hollow fibers is somewhat successful in slightly reducing the weight as compared with the use of microfine fibers, but provides only the substrates for artificial leathers with a very hard feel. In addition, such substrates made of hollow fibers loose their bulkiness during the use to eventually have a high apparent specific gravity even if having a low apparent specific gravity just after the production. Thus, the substrates for artificial leathers satisfying mechanical properties, soft and dense feel, and light weight simultaneously have been not conventionally produced.

### SUMMARY OF THE INVENTION

In the fields of using artificial leather materials, the light weight is frequently increases the commercial values. For example, in the applications to shoes, bags and clothing, the light weight of artificial leather materials is directly linked with the reduction of burden on the users of secondary products made therefrom. In the general applications of artificial leathers including the applications to exterior finishing materials for furniture, interior finishing materials for buildings and interior finishing materials for vehicles as well as the applications to industrial materials or sub-materials, the reduction of weight of secondary products creates various subsidiary effects. Since sports shoes, waking shoes, outdoor shoes, etc. are required to be well balanced in the shape retention (resistance to lost of shape), the protective properties (protection of user's foot from shock during exercise) and the flexibility, the upper materials generally should have a thickness of about 0.8 to 1.5 mm. In addition to the thickness regulated within the above range, the upper materials are required to have mechanical properties such as peeling strength and tear strength sufficiently enough to the end applications as well as soft, dense feel and light weight to obtain a good wearing comfort. However, since the soft, dense feel, excellent mechanical properties and the light weight are requirements which are contradictory to each other, the substrates for artificial leathers satisfying all the above requirements have not yet been obtained. In sports shoes, etc., the rubber sole and the upper materials are adhesively united and should be made resistant to structural fracture due to violent motion of wearers. Therefore, a great importance is given to the peel strength and the tear strength as the mechanical properties of upper materials for sport shoes, etc.

An object of the invention is to provide substrates for artificial leathers in which the mechanical properties, feel and light weight as required particularly in the applications to sport shoes, etc. are well balanced in a degree not attained in those conventionally known. Another object of the invention is to provide artificial leathers produced from such substrates.

In view of achieving the above objects, the inventors have made extensive research to produce a substrate for artificial leathers comprising an entangled nonwoven fabric made of microfine fibers and an elastic polymer impregnated into the entangled nonwoven fabrics, and simultaneously having excellent mechanical properties, a soft and dense feel and a low specific gravity which are not combinedly attained in the conventional techniques. As a result, the inventors have found that the most important factor for producing such a substrate is to minimize the change of shape of entangled nonwoven fabrics by forming the entangled nonwoven fabrics from bundles of polyamide microfine fibers having a high tenacity. The inventors have further found that such a substrate for artificial leathers simultaneously and sufficiently satisfies all the mechanical properties, flexibility and reduction of weight even after applied to sport shoes, etc.

Thus, the invention provides a substrate for artificial leathers having an apparent specific gravity of 0.30 or less and a tear strength of 50 N/mm or more, which comprises an entangled nonwoven fabric and an elastic polymer impregnated into intervening spaces in the entangled nonwoven fabric, said entangled nonwoven fabric being mainly made of bundles of polyamide microfine fibers having an average single fiber fineness of 0.2 dtex or less, and said bundles having an average tenacity of 3.5 cN/dtex or more and an average elongation of 60% or less. The weight increase by hot toluene (degree of apparent weight increase when swelled by hot toluene) of the elastic polymer is preferably 40% or less, and the hot-toluene wet elongation is preferably 200% or less.

The invention further provides a grain-finished artificial leather having a wet adhesive peel strength of 30 N/cm or more, which is produced by laminating a cover layer of an elastic polymer onto at least one surface of the substrate for artificial leathers.

The invention still further provides a napped artificial leather which is produced by making at least one surface of the substrate for artificial leathers into a napped surface mainly comprising polyamide microfine fibers.

The invention still further provides a method for producing a substrate for artificial leathers comprising the following sequential steps a to e:
(a) a step of melt-spinning composite fibers which comprises a polyamide resin having a number average molecular weight of 15000 or more and a fiber-forming polymer incompatible with the polyamide resin, and which is capable of being converted into microfine fibers of the polyamide resin;
(b) drawing the composite fibers at a drawing ratio of 3.0 times or more into drawn composite fibers having an elongation at break of 60% or less, and cutting the drawn composite fibers into cut fibers;
(c) carding the cut fibers into a web, entangling the web by needle punching optionally after superposing a plurality of webs, and optionally pressing the needle-punched web, thereby obtaining an entangled nonwoven fabric having an apparent specific gravity of 0.22 or less;
(d) impregnating a solution or dispersion of an elastic polymer into the entangled nonwoven fabric, and then coagulating the elastic polymer; and
(e) converting the composite fibers constituting the entangled nonwoven fabric into polyamide microfine fibers having a single fiber fineness of 0.2 dtex or less.

The bundles of polyamide microfine fibers constituting the entangled nonwoven fabric of the substrate for artificial leathers have an average tenacity of 3.5 cN/dtex or more and an average elongation of 60% or less. Namely, in addition to a sufficient flexibility, the bundles have an unprecedented toughness against the change of its shape such as bending and elongation. Therefore, the bulkiness of the entangled nonwoven fabric and the elastic polymer impregnated into the intervening spaces thereof can be substantially retained after the formation of microfine fibers. This enables the substrate for artificial leathers to have an extremely high tenacity (tear strength of 50 N/mm or more) irrespective of its extremely low apparent specific gravity (0.30 or less) hitherto not attained.

In the grain-finished artificial leathers produced by laminating a cover layer made of elastic polymer onto at least one surface of the substrate for artificial leathers, a high adhesive peel strength (wet adhesive peel strength of 30 N/cm or more) can be achieved irrespective of their low specific gravity hitherto not attained and soft, dense feel comparable to those conventionally attained.

### DETAILED DESCRIPTION OF THE PREFERRED EMBODIMENT

The substrate for artificial leathers of the invention comprises an entangled nonwoven fabric mainly made of bundles of polyamide microfine fibers having an average single fiber fineness of 0.2 dtex or less (polyamide microfine fiber bundles) and an elastic polymer impregnated into intervening spaces in the entangled nonwoven fabric. The polyamide microfine fiber bundles simultaneously satisfy an average tenacity of 3.5 cN/dtex or more, preferably 4 to 7 cN/dtex, and an average elongation of 60% or less, preferably 40 to 60%. These properties of microfine fiber bundles are critical for (1) attaining a low apparent specific gravity of 0.30 or less, preferably 0.10 to 0.30 which is hitherto not attained, while having a soft and tough feel well comparable to the feel of known artificial leathers, (2) attaining a tear strength which is the same as or higher than that of known substrates for artificial leathers having an apparent specific gravity of 0.35 or more, specifically, a tear strength of 50 N/mm or more, preferably 55 N/mm or more, and more preferably 60 to 150 N/mm; and (3) obtaining a substrate for artificial leathers which is capable of providing grain-finished or napped artificial leathers having a soft and dense feel comparable to that of known artificial leathers, particularly, grain-finished artificial leathers having a high adhesive peel strength represented by a wet adhesive peel strength of 30 N/cm or more. Polyamide microfine fiber bundles having an average tenacity lower than 3.5 cN/dtex or an average elongation exceeding 60% cannot provide a substrate for artificial leathers which satisfies all the requirements (1) to (3) simultaneously. To make the apparent specific gravity of substrate for artificial leathers made of polyamide microfine fibers to 0.30 or lower, the entangled nonwoven fabric constituting the substrate for artificial leathers should have a shape retention such as resistance to change under external forces and an excellent recovery from deformation. It is also important for the substrate for artificial leathers to have excellent feel which is well balanced with mechanical properties. To meet also these requirements, the above properties are critical. The number of single fibers in each polyamide microfine fiber bundle is generally 10 to 1000, but not specifically limited thereto as far as the above requirements are satisfied.

To obtain the polyamide microfine fiber bundles meeting the above requirements, it is necessary to use a high-tenacity polyamide resin as the fiber component and to employ a spinning method which allows the high tenacity of the polyamide resin to be sufficiently exhibited even after made into microfine fibers. The number average molecular weight of the polyamide resin is 15000 or more, preferably 17000 to 22000 for obtaining a high tenacity. If lower than 15000, high-tenacity microfine fiber bundles usable in the invention cannot be obtained even if produced by the following spinning method. If higher than 22000, the melt viscosity of a spinning liquid containing the polyamide resin becomes excessively high at a temperature range, 290° C. or lower, suitable for melt spinning. Therefore, the composite fibers having a fineness usable in the invention cannot be obtained and only produced are hard and less flexible composite fibers having a large fineness which are not applicable to the substrates for artificial leathers but applicable only to industrial materials such as air bags and tents. Although the composite fibers having a fineness usable in the invention may be produced by increasing the spinning temperature to reduce the melt viscosity of spinning liquid, the polyamide resin is thermally decomposed and practically usable composite fibers are not obtained. Thus, polyamide resins having a number average molecular weight larger than 22000 are not preferred. In addition to the polyamide resin used in the invention, polyester resins such as polyethylene terephthalate, polytetramethylene terephthalate and modified polyethylene terephthalate have been generally used as the microfine fiber-forming component. By drawing the composite fibers including polyester resin as the microfine fiber-forming component in a high draw ratio, the tenacity of the resultant microfine fibers can be easily increased. However, since the specific gravity of polyester resin is higher than that of polyamide resin by 20% or more, the amount of fibers for constituting the substrate should be considerably reduced in order to attain an apparent specific gravity of 0.30 or lower as compared with the use of polyamide, thereby failing to provide a substrate for artificial leathers which has also a high mechanical properties such as a tear strength of 50 N/m or more and a good feel such as dense feel. Therefore, only the polyamide described above is used in the invention as the component for forming microfine fibers.

The method for spinning the composite fibers for forming the polyamide microfine fiber bundles is described below. A polyamide resin for constituting the microfine fibers and one or more incompatible resins which form segments separated from the polyamide resin segments in the fiber cross section are melt-spun into composite fibers which are then drawn under the following conditions. The incompatible resin is selected from resins soluble in hot toluene heated to 80 to 85° C. or higher such as polyethylene and polystyrene.

The melt-spun composite fibers are hot-drawn by a dry-heat method or wet-heat method at a drawing ratio of 3.0 times or more, preferably 3.5 to 5.0 times so as to make the elongation at break of drawn composite fibers to 60% or less, preferably 25 to 60%, more preferably 40 to 60%. The drawing temperature is not specifically limited because it varies depending on various production factors such as types of resins to be combinedly spun, grades of resins, spinning method such as mix spinning and composite spinning, types of composite fibers such as sea-island type and splittable type, spinning conditions such as spinning speed and fineness after spinning, and drawing method such as dry heating and wet heating. Taking these production factors into consideration, the drawing temperature is selected from the range of about 25° C. (room temperature) to about 200° C. (temperature close to the melting point of polyamide) so that the elongation at break after drawing will be regulated within the above range. With such a drawing, microfine fiber bundles having an unprecedentedly high average tenacity of 3.5 cN/dtex or more can be obtained while the bundles are collective masses of extremely fine fibers having an average single fiber fineness of 0.2 dtex or less.

The unprecedentedly high tenacity of microfine fiber bundles irrespective of the fine average fineness of 0.2 dtex or less of constituent microfine fibers may be attributable to a highly crystallized state nearly ideal for microfine fibers which is achieved by the drawing of the polyamide microfine fiber component of the melt-spun composite fibers at a drawing ratio of 3.0 times or more under the conditions so controlled as to make the elongation at break of drawn composite fibers to 60% or less.

If the drawing ratio is less than 3.0 times, the high-tenacity polyamide microfine fiber bundles described herein cannot be obtained even if the elongation at break of drawn composite fibers is made into 60% or less, because the crystallized state of polyamide microfine fiber component is far from the ideal state. A drawing ratio exceeding 5.0 times is not preferred because the production stability is deteriorated by break of fibers, etc. If the elongation at break of drawn composite fibers exceeds 60%, the high-tenacity polyamide microfine fiber bundles described herein cannot be obtained because the crystallize state is far from the ideal state as mentioned above. If the elongation at break of drawn composite fibers is less than 25%, polyamide microfine fiber bundles having a tenacity far higher than the preferred range of the invention may be obtained. However, when it is intended to make the elongation at break of drawn composite fibers into less than 25%, the composite fibers must be drawn at a drawing ratio extremely close to their elongation at break. Generally, the composite fibers are drawn in the form of buddle of several hundreds, several thousands, or in some case several tens of thousands of composite fibers. In such a drawing operation, the break of fibers frequently occurs because of uneven elongation at break between the bundled composite fibers if the elongation at break of drawn composite fibers is less than 25%. The average tenacity of resultant microfine fibers becomes higher if the elongation at break of drawn composite fibers are as low as possible within the range of 60% or less. However, it is preferred in the invention to regulate the average tenacity of microfine fibers within the above preferred range without increasing it unduly, because the microfine fibers in the substrate for artificial leathers are allowed to elongate according to the degree of stress to make the entangled nonwoven fabric tough against the deformation stress and enhance the tear strength. Such a toughness of the entangled nonwoven fabric is preferred for the feel of substrate for artificial leathers because a moderate flexibility and dense feel are obtained.

If the elongation at break of composite fibers after drawn at a drawing ratio of less than 3.0 times becomes nearly 25%, the break of fibers occurs frequently when drawn at a drawing ratio of 3.0 times or higher. In this case, to draw at a drawing ratio of 3.0 times or higher while avoiding frequent break of fibers, i.e., while preventing the elongation at break after drawing from becoming less than 25%, it is effective to increase the fineness of spun composite fibers. For example, in case where the elongation at break of spun composite fibers having a fineness of 8 dtex becomes about 25% when drawn in a drawing ratio of less than 3.0 times, for example, 2.8 times, the elongation at break of spun composite fibers can be made into 25% or more thereby to ensure the drawing free from frequent break of fibers even at a high drawing ratio of 3.4 times or more, if the fineness after spinning is increased, for example, to about 8.5 to 9 dtex by increasing the discharging amount from spinneret while maintaining the spinning speed constant or by decreasing the spinning speed while maintaining the discharging amount constant.

The types of composite fibers used in the invention are not specifically limited, and preferably usable are microfine fiber-forming composite fibers such as sea-island or dividable multi-component fibers which are capable of forming bundles of polyamide microfine fibers by the extractive removal of the removable component (incompatible resin) different from polyamide in the solubility and decomposability; and splittable multi-component fibers which are converted into microfine fibers by splitting the polyamide segment and the segment of another resin (incompatible resin) which is suitably low in the adhesion to and compatibility with polyamide along their interface by mechanical action or volume change due to thermal expansion or solvent swelling. The bundles of microfine fibers obtained from such composite fibers comprise several to several thousand of microfine fibers having a single fiber fineness of 0.2 dtex or less, preferably 0.1 dtex or less, more preferably 0.0001 to 0.08 dtex, and are preferred for producing a highly flexible substrate for artificial leathers. In a preferred embodiment of the invention, the bundles of fibers and the fibers for forming the entangled nonwoven fabrics are constituted by a combination of microfine fibers having different single fiber finenesses to control the dyeability, mechanical properties and other properties. If the single fiber fineness is larger than 0.2 dtex, the flexibility of substrate for artificial leathers tends to be lowered and the microfine fibers tend to become easily pulled out from the entangled nonwoven fabric to reduce the adhesive peel strength and tear strength of resultant substrate for artificial leathers. This may be attributable mainly to the reduced resistance against abrasion between fibers because, upon comparing entangled nonwoven fabrics having the same fiber weight, the surface area of fibers becomes relatively small when fibers having a larger single fiber fineness are used.

The polyamide resin for constituting the microfine fibers can be selected from known polyamide resins. Example thereof include nylons such as nylon 4, nylon 6, nylon 66, nylon 7, nylon 11, nylon 12 and nylon 610; nylon copolymers copolymerized the above nylon; nylon copolymers copolymerized with a modifier; and blends of the above nylons, with nylon 6 being most preferred in view of the balance of mechanical properties, dyeability, etc. of fibers.

It is preferred, if desired, to color the microfine fibers during their production. The coloring method includes a method in which the polyamide resin is mixed in advance with carbon fine particles, titanium oxide fine particles or other pigment fine particles and then spun into microfine fiber-forming composite fiber, and a method in which the microfine fibers are colored by dye, with the former method being preferred in view of color fastness. In case of mixing the spinning raw material containing the polyamide resin with the pigment fine particles in advance, a colored spinning raw material containing a predetermined amount of pigment fine particles may be prepared and spun, or a high-concentration colored spinning raw material containing the pigment fine particles in an amount larger than the predetermined amount may be prepared and then spun after mixed with a non-colored spinning raw material so as to have a predetermined pigment concentration. Generally, the former method is preferred in view of spinning stability and the later method is preferred in view of production costs. These method are selected according to various production factors.

The nonwoven fabric for forming the substrate for artificial leathers is formed from the microfine fiber-forming composite fibers obtained as mentioned above in a manner conventionally known. The nonwoven fabrics are roughly classified into a staple nonwoven fabric and a filament nonwoven fabric based on fiber length, into a drylaid nonwoven fabric and a wetlaid nonwoven fabric based on method of forming nonwoven mass of fibers, i.e., web-forming method; and into a needle-punched nonwoven fabric and a hydroentangled nonwoven fabric based on entangling method of web-forming fibers. The entangled nonwoven fabric is produced by combining the above features according to intended application and desired properties, feel and their balance of the substrate for artificial leathers. In the invention, any combination of the above features may be used without specific limitation as far as the intended substrates for artificial leathers are obtained. Preferably, an entangled nonwoven fabric produced by needle-punching a stack of two or more drylaid webs each made of staples of 20 to 100 mm long or filaments is mainly used in the invention. By using such a nonwoven fabric, the apparent specific gravity and tear strength essential to the substrate for artificial leathers of the invention, excellent properties of grain-finished artificial leathers and napped artificial leathers, and performance in feeling such as feel and touch become well-balanced and can be stably achieved.

To make the apparent specific gravity of the substrate for artificial leathers comprising the entangled nonwoven fabric and the elastic polymer to 0.30 or less, the entangled nonwoven fabric before impregnated with the elastic polymer and before made into microfine fibers should have an apparent specific gravity of 0.22 or less, preferably 0.07 to 0.22. Once the entangled nonwoven fabric is produced, it changes the shape and increases its specific gravity in the subsequent steps. Since the shape retention of the entangled nonwoven fabric is inevitably reduced after making the composite fibers into bundles of microfine fibers, the shape of entangled nonwoven fabric is changed to increase its apparent specific gravity during the step of forming microfine fibers and in the subsequent steps because of forces applied from various directions, particularly a strong compressive force into the depth direction. Therefore, if the entangled nonwoven fabric before impregnated with the elastic polymer and made into microfine fibers has an apparent specific gravity exceeding 0.22, the apparent specific gravity of substrate for artificial leathers cannot be made to 0.30 or less even when the bundles of microfine fibers have a high tenacity and the entangled nonwoven fabric has a high shape retention.

It is preferred to insert a knitted or woven fabric into the entangled nonwoven fabric to enhance the entangled structure in plane direction or depth direction. If the knitted or woven fabric is inserted, the position in the depth direction is important. When inserted at the position nearer to the surface opposite to the surface to be grain-finished or napped, the affect of the rough and regular unevenness characteristic to the knitted or woven fabric on the appearance of artificial leather can be reduced to the smallest possible extent. By inserting a knitted or woven fabric having a feel and toughness different from those of entangled nonwoven fabric into the position near the surface, unique feel and toughness can be obtained. In addition, by inserting a knitted or woven fabric made of microfine fibers or microfine fiber-forming composite fibers, napped artificial leathers having natural appearance and feel can be obtained.

Prior to the impregnation of the elastic polymer into the entangled nonwoven fabric thus obtained, it is preferred to heat-press the entangled nonwoven fabric by heating and then pressing under cooling or by pressing under heating and then cooling to regulate the apparent specific gravity within intended range and make the surface of entangled nonwoven fabric flat and smooth. With such a heat press, good process passing properties in the steps after forming the entangled nonwoven fabric, a uniform distribution of elastic polymer in the entangled nonwoven fabric, a surface flatness and smoothness of resultant substrate for artificial leathers, and a uniform napping of napped artificial leather can be attained. The heating temperature is preferably near the softening temperature of the removable component of composite fibers forming the entangled nonwoven fabric, i.e., the sea component resin if the composite fibers are sea-island composite fibers. If the sea component resin is polyethylene, the heating temperature is preferably 95 to 130° C. The removable component of microfine fiber-forming composite fibers forming the entangled nonwoven fabric is preferably exposed to the surface of the composite fibers to occupy ⅓ or more of the overall periphery of fibers. By using a removable component having a softening temperature lower than that of the microfine fiber-forming component (polyamide resin), the heat press is conducted by heating the entangled nonwoven fabric at a temperature equal to or higher than the softening temperature of the removable component but lower than the softening temperature of the microfine fiber-forming component. During the heat press, adjacent microfine fiber-forming composite fibers are fuse-bonded to each other by the binder effect of the low softening component to make it easy to attain the intended apparent specific gravity and make the surface of entangled nonwoven fabric flat and smooth.

Then, the elastic polymer is impregnated into the entangled nonwoven fabric thus obtained. The impregnating amount of elastic polymer varies depending on mechanical properties, apparent specific gravity, feel, etc. of the resultant substrate for artificial leathers, and preferably 20 to 500 parts by weight based on 100 parts by weight of entangled nonwoven fabric after made into microfine fibers. The feel tends to become paper-like with the amount of elastic polymer impregnated into the entangled nonwoven fabric is decreased, and this tendency becomes significant if the amount is less than 20 parts by weight. If exceeding 500 parts by weight, the rubber-like feel of the elastic polymer becomes dominant. Since the paper-like feel and rubber-like feel become remarkable with increasing thickness of the substrate for artificial leathers, the impregnating amount of elastic polymer is more preferably 35 to 350 parts by weight for the application to shoes and bags requiring a thickness of 0.8 mm or more, but not for the application to clothing and gloves requiring thin material. In the invention, the elastic polymer is first impregnated into the entangled nonwoven fabric, and then, the microfine fiber-forming composite fibers are converted into microfine fibers by solvent treatment. If the elastic polymer is impregnated into an entangled nonwoven fabric after made into microfine fibers, the elastic polymer adheres to microfine fibers or further penetrates into the microfine fiber bundles to constrain the structure of entangled nonwoven fabric, thereby making the feel of substrate for artificial leathers hard and reducing their properties such as tear strength. To avoid the adhesion to the microfine fibers or penetration into the microfine fiber bundles of the elastic polymer, the microfine fibers and microfine fiber bundles are generally enveloped by a sizing agent such as polyvinyl alcohol prior to the impregnation of elastic polymer. Although the use of the sizing agent is applicable, it is preferred for the invention, as mentioned above, to impregnate the elastic polymer into the entangled nonwoven fabric before converting the microfine fiber-forming composite fibers into microfine fibers because the adhesion to the microfine fibers and penetration into the microfine fiber bundles are more surely prevented.

As the elastic polymer, polyurethane is preferably used in view of the balance with the feel of entangled nonwoven fabric and the durability in general use of substrate for artificial leathers. Polyurethane may be blended with a colorant or another functional agent, or blended with another elastic polymer such as olefin-based elastomer, styrene-based elastomer, polyester-based elastomer and vinyl chloride-based elastomer to control the modulus, in an amount not adversely affect the required properties. When the microfine fiber-forming composite fibers are converted into microfine fibers by the extractive removal of a hot-toluene soluble resin, a polyurethane having a weight increase by hot toluene of 40% or less and a hot-toluene wet elongation of 200% or less is preferred, and a polyurethane having a weight increase by hot toluene of 5 to 25% and a hot-toluene wet elongation of 45 to 185% is more preferred. If one or both the weight increase by hot toluene and the hot-toluene wet elongation are outside the above ranges, the elastic polymer scarcely contributes to the prevention of change of shape in various directions such as elongation in length direction, shrinkage in width direction and compression in depth direction during the step for removing the hot-toluene soluble resin. Therefore, the shape retention of composite sheet comprising the entangled nonwoven fabric and the elastic polymer is governed only by the shape retention of entangled nonwoven fabric. However, the shape retention of entangled nonwoven fabric in depth direction is relatively low, the composite sheet is compressed to increase the specific gravity. Therefore, when the microfine fiber-forming composite fibers are converted into microfine fibers by the extractive removal of a hot-toluene soluble resin, to stably produce a substrate for artificial leathers having an unprecedentedly low apparent specific gravity of 0.30 or less, the weight increase by hot toluene and the hot-toluene wet elongation are preferably within the above ranges.

The important factors to determine the weight increase by hot toluene and the hot-toluene wet elongation of polyurethane include molecular weight, degree of crosslinking, solubility parameter (SP value) of polymer diol for forming soft segment, SP value of diisocyanate for forming hard segment, and main chain length of chain extender. The weight increase by hot toluene and the hot-toluene wet elongation tend to be lowered as the molecular weight increases, or as the degree of crosslinking increases. Therefore, it is preferred to make the molecular weight and degree of crosslinking high according to the solubility of polyurethane, stability of solution or dispersion, coagulation tendency, and feel and properties of resultant substrate for artificial leathers, although the details of soft segment, hard segment and chain extender can be suitably determined according to the factors described below, applications of substrate for artificial leathers and balance with the entangled nonwoven fabric to be combined. A common solvent-soluble polyurethane for wet coagulation is difficult to be cross-linked and the degree or crosslinking is controlled within a narrow range. However, a solvent-soluble or water-dispersible polyurethane for dry coagulation is easily cross-linked and the degree of crosslinking can be controlled within a wide range. Therefore, the degree of crosslinking is a useful measure for controlling the weight increase by hot toluene and the hot-toluene wet elongation, particularly for the latter.

The weight increase by hot toluene and the hot-toluene wet elongation, particularly the former, tend to become small as the difference between SP value of polymer diol for forming soft segment and SP value of toluene becomes large. The weight increase by hot toluene and the hot-toluene wet elongation roughly tend to become small when the soft segment is a polyester polymer diol rather than a polyether polymer diol or polycarbonate polymer diol, and a polymer diol has a shorter main chain and a small amount of shorter side chain if compared within the same types. Therefore, in view of the weight increase by hot toluene and the hot-toluene wet elongation, polymethylpentene adipate diol and polyethylenepropylene adipate glycol are preferred and polybutylene adipate glycol and polyethylene adipate glycol are more preferred over polytetramethylene ether glycol, polycaprolactone glycol and polyhexamethylene carbonate diol.

The weight increase by hot toluene and the hot-toluene wet elongation tend to become small as SP value of diisocyanate for forming hard segment increases. The weight increase by hot toluene and the hot-toluene wet elongation roughly tend to become small by using an alicyclic diisocyanate rather than a aliphatic diisocyanate, using an aromatic diisocyanate rather than an alicyclic diisocyanate, and using an aromatic diisocyanate having two aromatic rings rather than an aromatic diisocyanate having one aromatic ring. Therefore, in view of the weight increase by hot toluene and the hot-toluene wet elongation, 4,4′-dicyclohexylmethane diisocyanate is preferred, toluylene diisocyanate is more preferred, and 4,4′-diphenylmethane diisocyanate is still more preferred over hexamethylene diisocyanate.

Since the weight increase by hot toluene and the hot-toluene wet elongation tend to become small as the chain length of chain extender becomes short, the chain extender is selected from low molecular weight diols as far as the properties of polyurethane are not adversely affected. As the low molecular weight diol, preferred is butanediol and more preferred is ethylene glycol over hexanediol. In addition to the low molecular weight diol, diamines such as aliphatic diamines, alicyclic diamines and aromatic diamines have been generally used as the chain extender for the polyurethane to be impregnated into the substrate for artificial leathers. However, since the reactivity of diamines is extremely high as compared with diols, it is difficult to increase the proportion of hard segment in the composition of polyurethane. Therefore, in the production of a substrate for artificial leathers having an apparent specific gravity of 0.30 or less, it is difficult to achieve the intended properties required for the substrate for artificial leathers. Thus, the low molecular weight diol should be mainly used in the invention as the chain extender, although the diamine may be combinedly used with the low molecular weight diol as the major chain extender as long as the properties required for the intended application can be achieved.

Taking the above factors into full consideration, the chemical composition of polyurethane is suitably selected so as to satisfy the performance required in applications of substrate for artificial leathers, i.e., mechanical properties such as tenacity and elongation, feel such as dense feel and touch, resistance to deterioration and color fastness to heat and light, and durability such as resistance to deterioration by oxidation and resistance to hydrolysis. The polyurethane having the above chemical composition may be used alone. However, to control the modulus, colorability, durability, etc., a polyurethane having another chemical composition may be added to the above polyurethane or its raw material in a suitable amount for attaining the intended weight increase by hot toluene and hot-toluene wet elongation.

Like the microfine fibers, the elastic polymer may be colored, if desired, during the production of substrate for artificial leathers, for example, by mixing carbon fine particles, titanium oxide particles or another pigment particles into the elastic polymer in advance at the time of impregnation into the entangled nonwoven fabric, or by coloring the elastic polymer by pigment or dye mentioned above after impregnating into the entangled nonwoven fabric. In view of color fastness, the former method is preferred. If the elastic polymer is colored by the above methods, the coloring of microfine fibers may be omitted.

The elastic polymer is introduced into the entangled nonwoven fabric in a liquid form such as solution, dispersion and melt by impregnation or application and then dry-coagulated or wet-coagulated. Since the substrate for artificial leathers of the invention has a extremely coarse texture as expressed by the apparent specific gravity of 0.30 or less, the elastic polymer should be relatively uniformly and sparsely distributed throughout the entangled nonwoven fabric. Therefore, it is not preferred to completely occupy the intervening spaces of entangled nonwoven fabric. To prevent such a problem, it is preferred to introduce a solution or dispersion having a low concentration of 5 to 15% and coagulate it. The elastic polymer is more preferably coagulated so as to form a micro porous structure containing voids of about 5 to 200 μm average size, because a low specific gravity and a good feel are obtained.

Before or after, preferably after, the impregnation of elastic polymer into the entangled nonwoven fabric, the microfine fiber-forming composite fibers are subjected to mechanical or chemical treatment to convert the entangled nonwoven fabric into an entangled nonwoven fabric made of microfine fibers, thereby producing the substrate for artificial leathers of the invention. The microfine fiber-forming composite fibers of splittable type are converted into microfine fibers by mechanical treatment to cause split along the interface between different components, such as crumpling treatment, beating treatment and liquid stream treatment in combination with coloring treatment, or by chemical treatment to reduce or remove the removable component with a decomposer or solvent. The microfine fiber-forming composite fibers of sea-island type are converted into microfine fibers by chemical treatment to reduce or remove the sea component with a decomposer or solvent. Since it is generally rather difficult to produce the effect of mechanical treatment uniformly throughout the entangled nonwoven fabric, the chemical treatment is preferred because the decomposition or dissolution of the component to be reduced or removed in composite fibers, i.e., the sea component of sea-island fibers, can be easily effected throughout the entangled nonwoven fabric. When the component to be reduced or removed is hot-toluene soluble, most preferred is the chemical treatment by extractive removal with hot toluene. The substrate for artificial leathers of the invention thus produced has a thickness, preferably, of 0.7 to 5.0 mm. If designed to obtain a thickness of less than 0.7 mm, a substrate for artificial leathers having an apparent specific gravity of 0.30 or less may be produced in the production under laboratory conditions without using the method of the invention because the tension applied to the substrate is quite small. However, in industrial continuous production, the substrate is subjected to a large change of shape particularly in its lengthwise direction because of tension, press, etc. in the production steps, thereby unfavorably increasing the apparent specific gravity beyond 0.30. If designed to obtain a thickness of more than 5.0 mm, the apparent specific gravity attained is low, but a long-term, high load extraction under a high press is required to extract the sea component to cause the change of shape during the production steps. In addition, the extraction is not successfully conducted even under high load extraction conditions, and the stable production tends to be difficult in common production facilities in view of insufficient process passing properties.

The substrate for artificial leathers thus produced or its thin slice taken along the major surface is made into a grain-finished artificial leather by forming a cover layer comprising an elastic polymer on at least one surface thereof. The cover layer may completely cover the surface of substrate for artificial leathers or may be partly cover the surface to allow the fibers and elastic polymer to be exposed to the surface. The former is called as gain finish and the latter as semi-grain finish, and the effect of the invention is obtained in both the finishes. The thickness of cover layer is preferably 0.1 to 300% of the thickness of substrate for artificial leathers.

The cover layer may be formed by a dry method, a wet method or a combined method of dry and wet methods without specific limitation. The dry method includes a method in which the elastic polymer in the form of solution, dispersion or melt is directly applied onto the surface of substrate for artificial leathers and then coagulated by heat treatment such as drying under heating, and a method in which a liquid of elastic polymer is applied onto a support and then a sheet form elastic polymer is adhered to the surface of substrate for artificial leathers at any time before coagulation, during coagulation by drying or after coagulation.

Since the substrate for artificial leathers has a low apparent specific gravity hitherto not attained, the elastic polymer for forming the cover layer penetrates into the substrate in depth direction more easily as compared with known substrates for artificial leathers. Therefore, the elastic polymer can easily penetrate into the surface portion of substrate for artificial leathers without unduly reducing the viscosity and concentration of solution or dispersion of elastic polymer, thereby allowing the cover layer and the substrate to be firmly united. If the bundles of microfine fibers are unduly constrained by the elastic polymer for uniting the cover layer and the substrate, the pliability of bundles of microfine fibers is lost to make the united cover layer and substrate weak against an external peeling force. As noted above, in the invention, the elastic polymer can be sufficiently introduced into the substrate without unduly reducing the viscosity and concentration of its solution or dispersion because of the unprecedentedly low apparent specific gravity of substrate for artificial leathers, and in addition, the elastic polymer can be introduced more deeply into the substrate even when the cover layer is formed in the same conditions as employed in the formation on a known substrate for artificial leathers having a high apparent specific gravity. Therefore, the adhesive peel strength between the substrate and the cover layer is made extremely high in the invention.

Particularly, the materials for shoes are required to have a high adhesive peel strength not only in a dry state but also in a wet state with rain, moisture, sweat, etc. Having the effects mentioned above, the grain-finished artificial leathers of the invention stably exhibit an adhesive peel strength as extremely high as 30 N/cm or more, preferably 35 to 70 N/cm even in a wet state.

The elastic polymer for forming the cover layer (covering elastic polymer) is preferably the same type as the elastic polymer for impregnating into the entangled nonwoven fabric (impregnating elastic polymer) in view of the adhesion between them and the balance of feel, and preferably polyurethane for the same reason as mentioned with respect to the substrate for artificial leathers. Also in view of the balance of feeling, properties, durability, etc. of resulting artificial leathers, the same polyurethane as exemplified above for impregnating into the entangled nonwoven fabric is preferably used as the covering elastic polymer. If the cover layer is colored by dyeing, the covering elastic polymer may be blended with an easily-dyeable component such as polyurethane having soft segment constituted by polyethylene glycol.

The grain-finished artificial leather can be colored into desired color simultaneously with the formation of the cover layer by blending a colorant such as dye and pigment into the covering elastic polymer in advance. Irrespective of such a coloring at the time of forming the covering layer, the covering layer may be colored by dyeing after its formation. The polyamide microfine fibers forming the substrate for artificial leathers may be dyed with acid dye, metal complex dye, disperse dye, sulfur dye, vat dye, etc. The dye for optional fibers to be combinedly used with the polyamide microfine fibers, the impregnating elastic polymer or the covering elastic polymer are suitably selected from dyes capable of dyeing the fibers and elastic polymers. The dyes are used singly or in combination, and there is no specific limitation in the invention on the types of dye and methods of dyeing.

The napped artificial leather of the invention is produced by raising naps on at least one surface of the substrate for artificial leathers obtained above and optionally finishing the raised naps in conventional manner so as to have a desired napped appearance and touch. The length of nap is usually 0.1 to 5.0 mm, although not accurately measured because the foot and top of nap are difficult to determine. The raising of naps is made by a method of using a buffing machine having an endless sandpaper, a method of using a raising machine having a card clothing, or a method of raising naps on a wet substrate for artificial leathers. To obtain a napped artificial leather with high-grade appearance and touch, it is generally preferred to raise naps by mainly using the buffing machine. The substrate for artificial leathers may be sliced along the major surface into two or more thin substrates prior to raising of naps, or a treating liquid containing the impregnating elastic polymer or silicone resin, etc. may be applied to the surface before or after raising naps or the sliced surface. Generally, these operations are optionally employed in the process for raising naps. In the invention, these operations may be suitably used in combination. The finishing of raised naps is made most preferably by brushing. Like the method for raising of naps, the finishing of raised naps may be made on a wet substrate for artificial leathers as far as the effect of the invention is not reduced.

The napped artificial leather of the invention may be colored before or after raising naps. The microfine fibers, i.e., the polyamide microfine fibers, forming the substrate for artificial leathers are mainly raised into naps in the invention. The dye for the polyamide microfine fibers is selected from acid dye, metal complex dye, disperse dye, sulfur dye, vat dye, etc. The dye for optional fibers to be combinedly used with the polyamide microfine fibers is suitably selected from dyes capable of dyeing the fibers. The dyes are used singly or in combination, and there is no specific limitation in the invention on the types of dye and methods of dyeing.

The invention will be described below with reference to examples. However, it should be noted that the scope of the invention is not limited thereto. In the followings, “part(s)” and “%” are based on weight unless otherwise noted. In the measuring methods, “machine direction” is the direction in which the substrate for artificial leathers flows, and “crosswise direction” is the direction perpendicular to the machine direction.

The properties were measured by the following methods.

(1) Average Single Fiber Fineness

The average cross-sectional area per one fiber in a fiber bundle was calculated by cross-sectionally observing a substrate for artificial leathers under a scanning electron micrograph. The calculation was made on the cross sections of ten bundles. The average single fiber fineness was calculated from the following formula:
Average single fiber fineness (dtex)=1.14×10⁻²×A
wherein A is the average (μm²) of 8 average cross-sectional areas omitting the maximum and minimum values. The average cross-sectional area per one fiber in a fiber bundle was the average of 10 fibers for a bundle constituted by less than 100 fibers and the average of 20 fibers for a bundle constituted by 100 or more fibers. If the substrate for artificial leathers was made of two or more types of bundles having different average fineness, the measurements were done on the major bundles.
(2) Average Tenacity and Elongation of Fiber Bundle

After removing an elastic polymer from a substrate for artificial leathers by dissolving into a solvent poor for nylon and good for the elastic polymer (for example, DMF if the elastic polymer is polyurethane), 20 fiber bundles were pulled out of the resultant entangled nonwoven fabric while taking a great care not to elongate or damage the bundles. The fineness of respective 20 samples was measured by a denier computer for measuring fineness (“DC-11B” available from Search Co., Ltd.). After inputting the measured fineness into a constant extension-type Tensilon tensile testing machine (“TSM-Olcre” available from Search Co., Ltd.), the breaking strength and the elongation at break were measured on each bundle at a grip distance of 20 mm and a pulling speed of 20 mm/min. The average of 18 measured values omitting the largest and smallest values was taken as the average tenacity and the average elongation.

(3) Weight Increase by Hot Toluene and Hot-Toluene Wet Elongation

The elastic polymer extracted with a solvent poor for nylon and good for the elastic polymer (for example, DMF if the elastic polymer is polyurethane) was made into a dry film of about 0.1 mm thick.

(3a) Weight Increase by Hot Toluene

Three 5 cm×5 cm square films taken out of the dry film were used as the specimens. After measuring the weight W_{A} of each specimen under standard conditions (20±2° C., 65±2 RH %), each specimen was immersed in toluene at 85° C. for 60 min. Immediately after wiping away the toluene from the both surfaces, each specimen was put into a weighed bag made of vinyl polymer to minimize the loss of toluene by evaporation, and then the weight W_{B} of each specimen was measured without delay. Using the measured weights W_{A} and W_{B}, the weight increase by hot toluene of each specimen was calculated from the following equation:
Weight increase by hot toluene (%)=100×(W_{B}−W_{A})/W_{A}.

The average of three calculated values was taken as the weight increase by hot toluene of elastic polymer.

(3b) Hot-Toluene Wet Elongation

Three 140 mm×25 mm rectangular films taken out of the dry film were used as the specimens. After immersing the specimens in toluene under the same conditions as above, each specimen was immediately wrapped with a polymer film, such as a commercially available polyethylene bag, which was already confirmed to be resistant to breaking, etc. at the temperature of specimens and the amount of toluene adhered to the specimens. Then the elongation was measured by a Tensilon tensile testing machine while minimizing the loss of toluene by evaporation under conditions of a 50 mm grip distance, a 100 mm/min pulling speed and a 9.8 N/mm² load. The average of three measured elongations was taken as the hot-toluene wet elongation of elastic polymer.

(4) Thickness and Apparent Specific Gravity

Measured respectively according to the methods of JIS L-1096:1999 8.5 and JIS L-1096:1999 8.10.1.

(5) Tear Strength

Measured according to the method of JIS K-6550-1994 5.3 with slight modification. Four specimens were cut out of a substrate for artificial leathers, two along the machine direction and other two along the crosswise direction. The length of shorter side was changed from 25 mm to 40 mm and the length of slit was changed from 70 mm to 50 mm. Then the thickness t (mm) of each specimen was measured while changing the measuring load to the value prescribed in JIS L-1096:1999 8.5. Then, the average load F₁ (N), in place of the maximum load, until the specimen was broken into parts by tearing was measured. The tear strength was calculated from the following equation using the averaged values of the measured thicknesses t and average loads F₁:
Tear strength (N/mm)=F₁/t.
(6) Wet Adhesive Peel Strength

Measured according to the method of JIS K-6854-2:1999. A crepe rubber plate (150 mm×27 mm×5 mm) made of polyurethane was used as the rigid adherend. From a grain-finished artificial leather, three deflecting adherends (length: 250 mm; width (w): 25 mm) were taken respectively along the machine direction and the crosswise direction. The grain-finished artificial leather and the rubber plate were adhered by a polyurethane two-part adhesive firmly enough to exhibit a sufficient adhesion strength, thereby preparing the specimen. The specimen immediately after immersed in distilled water for 10 min was subjected to a peel test at a peeling speed of 50 mm/min to obtain a stress-peeled length curve, from which the average peel force was obtained. The measured three average peel forces in each of the machine direction and the crosswise direction were arithmetically averaged. Using a smaller average value F₂ (N), the wet adhesive peel strength was calculated from the following equation:
Wet adhesive peel strength (N/cm)=F₂/w.
(7) Elongation at Break of Composite Fibers

A bundle of about 50 to 100 composite fibers was cut into 10 parts of about 30 cm long to prepare the specimens. The elongation at break was measured on each specimen by a Tensilon tensile testing machine under conditions of a grip distance of 100 mm and a pulling speed of 100 mm/min. The average of 8 measured values omitting the maximum value and the minimum value was taken as the elongation at break of composite fibers. Since the strength of single composite fiber is quite low, the measurement was made on the bundle of composite fibers to make the measurement possible. However, the use of the bundle of composite fibers is not critical for the measurement. The number of fibers in the bundle may be suitably selected depending on the number of holes of spinneret and the measurable range of the testing machine to be used. Since the fiber-to-fiber unevenness of elongation at break becomes negligible to ensure the measurement of average elongation at break, it is preferred to form the bundle from about 50 composite fibers.

The properties relating to sensory satisfaction were evaluated in the following manners.

(8) Feel of Grain-Finished Artificial Leather

A grain-finished artificial leather cut out into 10 to 30 cm square, preferably about 20 cm square, was used as the specimen for evaluation. By 10 persons randomly selected from manufacturers and distributors of artificial leathers, the suitability of grain-finished artificial leather as the upper material for sport shoes was evaluated based on a scale of 1 to 5, where the rating 3 is a general feel suitable for the upper material of sport shoes, the rating 1 is a feel not applicable to sport shoes because of excessively hard feel or lack of toughness due to excessively soft feel, and the rating 5 is a perfect feel having a softness in addition to a very good dense feel as compared with the general feel of rating 3. The results were expressed by the rating given by 5 or more persons or the rating given by 3 or more persons when the other ratings were given by only one or two persons. When every rating was given by two persons, the result was expressed by the rating 3.

(9) Feel of Napped Artificial Leather

A napped artificial leather cut out into 10 to 30 cm square, preferably about 20 cm square, was used as the specimen for evaluation. By 10 persons randomly selected from manufacturers and distributors of artificial leathers, the suitability of napped artificial leather as the upper material for sport shoes was evaluated based on a scale of 1 to 5, where the rating 3 is a general feel suitable for the upper material of sport shoes, the rating 1 is a feel not applicable to sport shoes because of excessively hard feel or lack of toughness due to excessively soft feel, and the rating 5 is a perfect feel having a softness in addition to a very good dense feel as compared with the general feel of rating 3. The results were expressed by the rating given by 5 or more persons or the rating given by 3 or more persons when the other ratings were given by only one or two persons. When every rating was given by two persons, the result was expressed by the rating 3.

(10) Touch of Napped Surface of Napped Artificial Leather

A napped artificial leather cut out into 10 to 30 cm square, preferably about 20 cm square, was used as the specimen for evaluation. By 10 persons randomly selected from manufacturers and distributors of artificial leathers, the touch of the napped surface was evaluated based on a scale of 1 to 5, where the rating 3 is a general touch suitable for the upper material of sport shoes, the rating 1 is a touch not applicable to a napped materials for sport shoes or other general uses because of excessively rough touch of the napped surface, and the rating 5 is a perfect touch having a very compact napping and a very smooth surface as compared with the general touch of rating 3. The results were expressed by the rating given by 5 or more persons or the rating given by 3 or more persons when the other ratings were given by only one or two persons. When every rating was given by two persons, the result was expressed by the rating 3.

### PRODUCTION EXAMPLE 1-1

Production of Composite Stables 1

Into a spinneret (nozzle diameter: 0.45 mm) having an inner structure for determining the fiber cross section by distribution and combination of two kinds of melts, a melt of nylon 6 (number average molecular weight: 18000) for the fiber component and a melt of low density polyethylene (melt index: 65 g/10 min at 190° C. under 2160 gf load) for the removable component were fed from separate feeding systems while metering by gear pumps. The composite melt extruded from the nozzles of spinneret was wound up on a bobbin while exposing to cooling air to prepare composite fibers having a cross section in which 50 nylon 6 segments of nearly the same dimension were dispersed in the matrix component of low density polyethylene. The ratio of nylon 6/low density polyethylene was 55/45 and the elongation at break was 420%. During the stable spinning operation, the feeding temperature of melt was about 300° C. for nylon 6 and about 270° C. for low density polyethylene, and the temperature of spinneret was about 305° C. The composite fibers were allowed to pass through a hot water bath at 80 to 85° C. and drawn by changing the speeds before and after passing the hot water bath. The ratio of speeds was about 3.9 (drawing ratio=3.9 times) and the elongation at break of drawn composite fibers was 45%. The drawn composite fibers were mechanically crimped, sprayed with an oil, and then cut into 51 mm long to obtain composite staples 1 having an average fineness of 6.2 dtex.

### PRODUCTION EXAMPLE 1-2

Production of Composite Stables 2

In the same manner as in Production Example 1-1 except for using a melt of nylon 6 (number average molecular weight: 13000) for the fiber component, composite fibers having a cross section in which 50 nylon 6 segments of nearly the same dimension were dispersed in the matrix component of low density polyethylene were prepared. The ratio of nylon 6/low density polyethylene was 65/35 and the elongation at break was 410%. During the stable spinning operation, the feeding temperature of melt was about 280° C. for nylon 6 and about 300° C. for low density polyethylene, and the temperature of spinneret was about 285° C. By drawing the composite fibers in the same manner as in Production Example 1-1 except for changing the speed ratio to 2.8 (drawing ratio: 2.8 times), drawn composite fibers having an elongation at break of 70% were obtained. The drawn composite fibers were mechanically crimped, sprayed with an oil, and then cut into 51 mm long to obtain composite staples 2 having an average fineness of 4.6 dtex.

### PRODUCTION EXAMPLE 1-3

Production of Composite Stables 3

Nylon 6 chips (number average molecular weight: 18000) for the fiber component and low density polyethylene chips (melt index: 65 g/10 min) for the removable component were blended in a weight ratio of 50:50. Into a spinneret (nozzle diameter: 0.30 mm) having an inner structure for forming a non-specified fiber cross section of single kind of melt, the composite melt of the blend was fed from a single feeding system while metering by a gear pump. The composite melt extruded from the nozzles of spinneret was wound up on a bobbin while exposing to cooling air to prepare composite fibers having a cross section in which several hundreds of nylon 6 segments of different dimensions were dispersed in the matrix component of low density polyethylene were prepared. The elongation at break was 380%. During the stable spinning operation, the feeding temperature of melt was about 285° C. and the temperature of spinneret was about 285° C. The composite fibers were allowed to pass through a hot water bath at 80 to 85° C. and drawn by changing the speeds before and after passing the hot water bath. The ratio of speeds was about 3.0 (drawing ratio=3.0 times) and the elongation at break of drawn composite fibers was 80%. The drawn composite fibers were mechanically crimped, sprayed with an oil, and then cut into 51 mm long to obtain composite staples 3 having an average fineness of 6.4 dtex.

### PRODUCTION EXAMPLE 2-1

Production of Polyurethane 1

Polyethylene propylene adipate (PEPA, number average molecular weight: about 2000) as the polyol component, ethylene glycol (EG) as the chain extender, diphenylmethane diisocyanate (MDI) as the diisocyanate component, and dimethylformamide (DMF) as the solvent were subjected to polymerization in a molar ratio of PEPA:EG:MDI=1:4:5 to prepare polyurethane 1. The nitrogen content of the polyurethane 1 was about 4.0%.

### PRODUCTION EXAMPLE 2-2

Production of Polyurethane 2

In the same manner as in Production Example 2-1 except for changing the molar ratio to PEPA:EG:MDI=1:5.7:6.7, polyurethane 2 was prepared. The nitrogen content of the polyurethane 2 was about 4.7%.

### PRODUCTION EXAMPLE 2-3

Production of Polyurethane 3

In the same manner as in Production Example 2-1 except for changing the polyol component to polyethylene glycol (PEG, number average molecular weight: about 2000), the polymerization was conducted in a molar ratio of PEPA:PEG:MDI=1:4:5 to prepare polyurethane 3. The nitrogen content of the polyurethane 3 was about 4.0%.

### EXAMPLE 1

After carding, the composite staples 1 were made into a web by a crosslap webber. The webs were superposed and punched with single barb needles by a needle punching machine from both sides thereof along the depth direction of webs to obtain an entangled nonwoven fabric. The needle punching was alternately made from one side and then from the other in a stroke allowing the barbs to pass through the webs, and then alternately made from one side and then from the other in a stroke not allowing the barbs to pass through the webs. The total punching density was 900 to 1000 barbs/cm². The entangled nonwoven fabric was heated in a steam dryer at 120 to 125° C. and then the surface thereof was smoothed by cold-pressing between a pair of metal rolls to prepare an entangled nonwoven fabric 1. The thickness was 1.9 mm and the apparent specific gravity was 0.18.

Into a DMF solution of a mixed polyurethane (polyurethane 1:polyurethane 2=3:7 by solid weight) having a polyurethane concentration of 13.5%, a small amount of alcohol surfactant was added as the coagulation regulator. After impregnated with the solution, the entangled nonwoven fabric 1 was introduced into a water bath containing DMF in a concentration of about 30% to coagulate the mixed polyurethane into porous structure and then washed with water to remove the DMF from the entangled nonwoven fabric. The entangled nonwoven fabric was immersed into a toluene bath heated to 85 to 95° C. to remove the low density polyethylene component from the composite staples by dissolution, and then the toluene was squeezed out of the entangled nonwoven fabric. The remaining toluene was completely removed as azeotrope by introducing the entangled nonwoven fabric into a hot water of about 100 to 120° C. After impregnated with a flexibilizer, the entangled nonwoven fabric was dried at about 130 to 150° C. in a pin-tenter steam dryer while controlling the width, thereby obtaining a substrate for artificial leathers 1 composed of the bundles of nylon 6 microfine fibers and the mixed polyurethane in a weight ratio of 54:46. The bundles were composed of nylon 6 microfine fibers having an average single fiber fineness of 0.08 dtex, and had an average tenacity of 4.4 cN/dtex and an average elongation of 47%. The mixed polyurethane had a weight increase by hot toluene of 18% and a hot-toluene wet elongation of 180%.

The substrate for artificial leathers 1 thus produced had a thickness of 1.25 mm, an apparent specific gravity of 0.27 and a tear strength of 78 N/mm. The properties of the substrate for artificial leathers 1 are shown in Table 1.

### EXAMPLE 2

In the same manner as in Example 1 except for adding carbon fine particles into the DMF solution of the mixed polyurethane in an amount of 2% based on the weight of solid mixed polyurethane, a substrate for artificial leathers 2 composed of the bundles of nylon 6 microfine fibers and the mixed polyurethane in a weight ratio of 56:44 was produced. The bundles were composed of nylon 6 microfine fibers having an average single fiber fineness of 0.08 dtex, and had an average tenacity of 4.4 cN/dtex and an average elongation of 47%. The mixed polyurethane had a weight increase by hot toluene of 20% and a hot-toluene wet elongation of 195%.

The substrate for artificial leathers 2 thus produced had a thickness of 1.23 mm, an apparent specific gravity of 0.28 and a tear strength of 65 N/mm. The properties of the substrate for artificial leathers 2 are shown in Table 1.

### COMPARATIVE EXAMPLE 1

In the same manner as in Example 1 except for using the composite staples 2, an entangled nonwoven fabric 2 having a thickness of 1.6 mm and an apparent specific gravity of 0.26 was produced. The entangled nonwoven fabric 2 was impregnated with a DMF solution of a mixed polyurethane (polyurethane 1:polyurethane 3=8:2 by solid weight) having a polyurethane concentration of 20.0% which had been added with a small amount of alcohol surfactant as the coagulation regulator. Then, by following the same procedure of Example 1, a substrate for artificial leathers 3 composed of the bundles of nylon 6 microfine fibers and the mixed polyurethane in a weight ratio of 55:45 was produced. The bundles were composed of nylon 6 microfine fibers having an average single fiber fineness of 0.06 dtex, and had an average tenacity of 3.0 cN/dtex and an average elongation of 65%. The mixed polyurethane had a weight increase by hot toluene of 28% and a hot-toluene wet elongation of 298%.

The substrate for artificial leathers 3 thus produced had a thickness of 0.98 mm, an apparent specific gravity of 0.36 and a tear strength of 75 N/mm.

The properties of the substrate for artificial leathers 3 are shown in Table 1.

### COMPARATIVE EXAMPLE 2

In the same manner as in Example 1 except for using the composite staples 3, an entangled nonwoven fabric 3 having a thickness of 1.6 mm and an apparent specific gravity of 0.26 was produced. Then, by following the procedure of Example 1 except for using the entangled nonwoven fabric 3, a substrate for artificial leathers 4 composed of the bundles of nylon 6 microfine fibers and the mixed polyurethane in a weight ratio of 60:40 was produced. The bundles were composed of nylon 6 microfine fibers having an average single fiber fineness of 0.08 dtex, an average tenacity of 3.0 cN/dtex and an average elongation of 48%. The mixed polyurethane had a weight increase by hot toluene of 26% and a hot-toluene wet elongation of 360%.

The substrate for artificial leathers 4 thus produced had a thickness of 0.94 mm, an apparent specific gravity of 0.37 and a tear strength of 68 N/mm. The properties of the substrate for artificial leathers 4 are shown in Table 1.

TABLE 1

| | | | Comparative | |
|---|---|---|---|---|
| | Examples | | Examples | |
| | 1 | 2 | 1 | 2 |
| Substrate for artificial leathers | 1 | 2 | 3 | 4 |
| Composite staples | 1 | 1 | 2 | 3 |
| Bundle of microfine fibers | | | | |
| average tenacity (cN/dtex) | 4.4 | 4.4 | 3.0 | 3.0 |
| average elongation (%) | 47 | 47 | 65 | 48 |
| Elastic polymer | | | | |
| weight increase by hot toluene (%) | 18 | 20 | 28 | 26 |
| hot-toluene wet elongation (%) | 180 | 195 | 298 | 360 |
| Apparent specific gravity | 0.27 | 0.28 | 0.36 | 0.37 |
| Tear strength (N/mm) | 78 | 65 | 75 | 68 |

### EXAMPLE 3

After rubbing lightly the surface of the substrate for artificial leathers 1 produced in Example 1 with a sandpaper of #180 grain size, a polyurethane cover layer was formed under the following conditions to produce a grain-finished artificial leather 1. The thickness was 1.38 mm, the apparent specific gravity was 0.34 and the wet adhesive peel strength was 58 N/cm. The properties and evaluation results on the sensory satisfaction of the grain-finished artificial leather 1 are shown in Table 2.

Conditions for Forming Polyurethane Cover Layer

After successively forming the following outermost layer and intermediate layer on a release paper by application and drying, an adhesive layer was applied onto the intermediate layer. The release paper with layers was superposed on the rubbed surface of the substrate for artificial leathers 1 while the adhesive layer was semi-dried and still adhesive and then allowed to pass between metal rolls (clearance: 0.9 mm). After aging for several days in an atmosphere of 40 to 50° C., the release paper was peeled away from the substrate. The resultant artificial leather was mechanically crumpled to produce a grain-finished artificial leather 1.

Release Paper: AR-130SG (Asahi Roll Co., Ltd.)

Outermost layer: ME 8115LP (Dainichiseika Color & Chemicals

| | |
|---|---|
| Outermost layer: ME 8115LP (Dainichiseika Color & | 100 parts |
| Chemicals Mfg. Co., Ltd.) | |
| DUT 4093 White (Dainichiseika Color & Chemicals | 20 parts |
| Mfg. Co., Ltd.) | |
| DMF | 35 parts |
| MEK | 15 parts |
| Application amount (solution basis) | 85 g/m² |

Intermediate layer: ME-8105LP (Dainichiseika Color & Chemicals

| | |
|---|---|
| Intermediate layer: ME-8105LP (Dainichiseika Color & | 100 parts |
| Chemicals Mfg. Co., Ltd.) | |
| DUT-4093 White (Dainichiseika Color & Chemicals | 30 parts |
| Mfg. Co., Ltd.) | |
| DMF | 30 parts |
| MEK | 20 parts |
| Application amount (solution basis) | 140 g/m² |

Adhesive layer: UD-8310 (modified) (Dainichiseika Color & Chemicals

| | |
|---|---|
| Adhesive layer: UD-8310 (modified) (Dainichiseika Color & | 100 parts |
| Chemicals Mfg. Co., Ltd.) | |
| DMF | 5 parts |
| MEK | 10 parts |
| Cross-linking agent | 10 parts |
| Promoter | 2 parts |
| Application amount (solution basis) | 140 g/m² |

Note:
AR-130SG: crumpled, cowskin-like release paper (SG = Semi Gloss)
ME-8115LP: polyether polyurethane solution (100% modulus = 80 to 90 kg/cm², solid content = 30%)
ME-8105LP: polyether polyurethane solution (100% modulus = 40 to 45 kg/cm², solid content = 30%)
DUT-4093 White: pigment colorant solution (pigment: titanium oxide, vehicle: polyether polyurethane, pigment concentration = 50%, solid content = 59%)
UD-8310 (modified): polyurethane adhesive solution (polyol component = polyether, solid content = 60%)
DMF: dimethylformamide
MEK: methyl ethyl ketone
Cross-linking agent: modified polyisocyanate solution
Promoter: low molecular urethane compound solution

### COMPARATIVE EXAMPLE 3

In the same manner as in Example 3 except for using the substrate for artificial leathers 3 produced in Comparative Example 1, a grain-finished artificial leather 2 was produced. The thickness was 1.12 mm, the apparent specific gravity was 0.44 and the wet adhesive peel strength was 36 N/cm. The properties and evaluation results on the sensory satisfaction of the grain-finished artificial leather 2 are shown in Table 2.

### COMPARATIVE EXAMPLE 4

In the same manner as in Example 3 except for using the substrate for artificial leathers 4 produced in Comparative Example 2, a grain-finished artificial leather 3 was produced. The thickness was 1.08 mm, the apparent specific gravity was 0.45 and the wet adhesive peel strength was 28 N/cm. The properties and evaluation results on the sensory satisfaction of the grain-finished artificial leather 3 are shown in Table 2.

TABLE 2

| | |
|---|---|
| | Comparative |
| Example | Examples |

| | 3 | 3 | 4 |
|---|---|---|---|
| Grain-finished artificial leather | 1 | 2 | 3 |
| Substrate for artificial leathers | 1 | 3 | 4 |
| Apparent specific gravity of grain- | 0.34 | 0.44 | 0.45 |
| finished artificial leather | | | |
| Wet adhesive peel strength (N/cm) | 58 | 36 | 28 |
| Feel | 4 | 4 | 5 |

### EXAMPLE 4

A mixed solution of DMF and cyclohexanone was applied onto the surface of the substrate for artificial leathers 1 produced in Example 1 by a 200-mesh gravure roll and then dried. The back surface not applied with the mixed solution was smoothed by rubbing lightly with sandpapers of #180 grain size and #240 grain size. Then, the surface was rubbed with a sandpaper of #600 grain size two to three times while suitably changing the rotation direction of the sandpaper to raise the microfine fibers in the surface portion of the substrate. Finally, by further rubbing the surface with a sandpaper of #600 grain size to order the raised naps, a non-dyed napped artificial leather having a napped surface of microfine fibers was produced. The napped artificial leather was dyed with a metal-containing complex dye prepared by suitably mixing dyes with different colors such as red, yellow, black and brown, and the raised microfine fibers were ordered by a rotary brush to obtain a brown napped artificial leather 1. The thickness was 1.14 mm and the apparent specific gravity was 0.32. The properties and evaluation results on the sensory satisfaction of the napped artificial leather 1 are shown in Table 3.

### COMPARATIVE EXAMPLE 5

In the same manner as in Example 4 except for using the substrate for artificial leathers 4 produced in Comparative Example 2, a light brown napped artificial leather 2 was produced. The thickness was 0.85 mm and the apparent specific gravity was 0.42. The properties and evaluation results on the sensory satisfaction of the napped artificial leather 2 are shown in Table 3.

TABLE 3

| | | Comparative |
|---|---|---|
| | Example 4 | Example 5 |
| Napped artificial leather | 1 | 2 |
| Substrate for artificial leathers | 1 | 4 |
| Apparent specific gravity of napped | 0.32 | 0.42 |
| artificial leather | | |
| Feel | 4 | 4 |
| Touch | 4 | 5 |

The substrate for artificial leathers of the invention comprises an entangled nonwoven fabric mainly made of bundles of polyamide microfine fibers having an average single fiber fineness of 0.2 dtex or less and an elastic polymer impregnated into intervening spaces in the entangled nonwoven fabric, and exhibit a soft, flexible and dense feel. A relatively casual napped artificial leather having elegant writing properties and a rough touch can be produced from the substrate for artificial leathers by raising its surface into, for example, a napped surface which is uniform throughout the surface but rough and relatively long, i.e., a suede-finished appearance. By making the surface into a more uniform, shorter napped surface as compared with the suede finish, i.e., a nubuck appearance, a high-grade napped artificial leathers having sharp writing properties and a smooth touch can be obtained. Thus, the substrate for artificial leathers of the invention provides appearances comparable to those obtained by conventionally known substrates for artificial leathers of similar constitution.

Since the entangled nonwoven fabrics are made of bundles of microfine fibers having a high tenacity, the substrates for artificial leathers and artificial leathers made thereof of the invention have mechanical properties required in various applicants and are well balanced in the soft and dense feel and the actual and practical light weight. The substrates for artificial leathers are suitable for use in general applications of artificial leathers such as materials for shoes, materials for bags, materials for clothing, and interior finishing materials for furniture, buildings and vehicles. The substrates for artificial leathers are also suitable for use in abrasives because of their highly elastic cushion properties in the thickness direction, easy control of the rotation number due to their small inertia at high speed rotation attributable to their light weight, and good surface smoothness and affinity with abrasive slurry attributable to the use of microfine fibers. Because of their low specific gravity and the use of microfine fibers, the substrates for artificial leathers has a high water absorption and oil absorption and are applicable to water absorbents and oil absorbents. In addition, the substrates for artificial leathers are suitably applicable to various types of cushions because of their improved immediate elastic recovery.

1. A substrate for artificial leathers having an apparent specific gravity of 0.30 or less and a tear strength of 50 N/mm or more, which comprises an entangled nonwoven fabric and an elastic polymer impregnated into intervening spaces in the entangled nonwoven fabric, said entangled nonwoven fabric being mainly made of bundles of polyamide microfine fibers having an average single fiber fineness of 0.2 dtex or less, and said bundles having an average tenacity of 3.5 cN/dtex or more and an average elongation of 60% or less.

2. The substrate for artificial leathers according to claim 1, the elastic polymer has a weight increase by hot toluene of 40% or less and a hot-toluene wet elongation of 200% or less.

3. The substrate for artificial leathers according to claim 1, the elastic polymer is in a porous state.

4. The substrate for artificial leathers according to claim 1, which is made into a grain-finished artificial leather having a wet adhesive peel strength of 30 N/cm or more by laminating a cover layer of an elastic polymer onto at least one surface of the substrate for artificial leathers.

5. The substrate for artificial leathers according to claim 1, which is made into a napped artificial leather by making at least one surface of the substrate for artificial leathers into a napped surface mainly comprising polyamide microfine fibers.

6. A method for producing a substrate for artificial leathers comprising the following sequential steps (a) to (e):
(a) a step of melt-spinning composite fibers which comprises a polyamide resin having a number average molecular weight of 15000 or more and a fiber-forming polymer incompatible with the polyamide resin, and which is capable of being converted into microfine fibers of the polyamide resin;
(b) drawing the composite fibers at a drawing ratio of 3.0 times or more into drawn composite fibers having an elongation at break of 60% or less, and cutting the drawn composite fibers into cut fibers;
(c) carding the cut fibers into a web, entangling the web by needle punching optionally after superposing a plurality of webs, and optionally pressing the needle-punched web, thereby obtaining an entangled nonwoven fabric having an apparent specific gravity of 0.22 or less;
(d) impregnating a solution or dispersion of an elastic polymer into the entangled nonwoven fabric, and then coagulating the elastic polymer; and
(e) converting the composite fibers constituting the entangled nonwoven fabric into polyamide microfine fibers having a single fiber fineness of 0.2 dtex or less.
